(19) United States
(12) Patent Application Publication
(10) Pub. No.: US 2026/0298831 A1
(43) Pub. Date: Oct. 1, 2026

(54) SAMPLE MEASUREMENT SYSTEM AND SAMPLE MEASUREMENT METHOD

(71) Applicant: SYSMEX CORPORATION, Hyogo (JP)

(72) Inventors: Yuki Akasaka, Hyogo (JP); Tomoyuki Nose, Hyogo (JP); Yusuke Hatae, Hyogo (JP); Hiroshi Kishimoto, Hyogo (JP)

(73) Assignee: SYSMEX CORPORATION, Hyogo (JP)

(21) Appl. No.: 19/577,341

(22) Filed: Mar. 24, 2026

(30) Foreign Application Priority Data
Mar. 28, 2025 (JP) 2025-054917

(51) Int. Cl. G01N 21/76; G01N 21/94

(52) U.S. Cl. CPC G01N 21/76; G01N 21/94

(57) ABSTRACT

A sample measurement system using a cartridge for preparing a measurement sample from a sample and a plurality of types of reagents includes: a cartridge holder configured to detachably hold the cartridge containing the measurement sample in a measurement chamber having a transparent member; a photodetector provided so as to face one surface of the cartridge held by the cartridge holder and configured to detect, via the transparent member, light emitted from the measurement sample in the measurement chamber; a driver configured to move at least one of the cartridge held by the cartridge holder and the photodetector; and a controller configured to obtain a measurement result of a target component in the measurement sample based on the light detected by the photodetector.

### CROSS REFERENCE TO RELATED APPLICATION

This application claims priority from prior Japanese Patent Application No. 2025-054917, filed on Mar. 28, 2025, entitled “SAMPLE MEASUREMENT SYSTEM AND SAMPLE MEASUREMENT METHOD”, the entire contents of which are incorporated herein by reference.

### TECHNICAL FIELD

The present invention relates to a sample measurement system and a sample measurement method for measuring a sample using a cartridge provided with a measurement chamber and a channel leading to the measurement chamber.

### BACKGROUND

Japanese Patent Publication No. 2015-531488 discloses a sample measurement apparatus that measures a sample using a cartridge provided with a measurement chamber and a channel leading to the measurement chamber.

### SUMMARY

In sample measurement using such the cartridge, a sudden high value may be observed. Although an entry of a foreign object into the cartridge is considered as a reason for the sudden high value, conventional measurement methods cannot rule out the possibility of an increase of antigen in the sample, and the cause could not be identified.

Therefore, there is a need for the sample measurement system and the sample measurement method which are capable of detecting a foreign object in the cartridge.

The present invention relates to a sample measurement system using a cartridge for preparing a measurement sample from a sample and a plurality of types of reagents, the system comprising:

a cartridge holder configured to detachably hold the cartridge containing the measurement sample in a measurement chamber having a transparent member; a photodetector provided so as to face one surface of the cartridge held by the cartridge holder and configured to detect, via the transparent member, light emitted from the measurement sample in the measurement chamber; a driver configured to move at least one of the cartridge held by the cartridge holder and the photodetector; and a controller configured to obtain a measurement result of a target component in the measurement sample based on the light detected by the photodetector, wherein the controller is configured to: control the driver to arrange the photodetector at a plurality of positions relative to the measurement chamber, and control the photodetector to detect the light emitted from the measurement sample in the measurement chamber at the plurality of positions; detect a foreign object in the measurement chamber based on a distribution of light amounts obtained by detecting the light at the plurality of positions; and wherein the plurality of positions include: a first position for detecting, by the photodetector, light from a first region of the measurement chamber; and a second position for detecting, by the photodetector, light from a second region of the measurement chamber.

A sample measurement method using a cartridge for preparing a measurement sample from a sample and a plurality of types of reagents, the method comprising steps of: moving at least one of the cartridge containing the measurement sample in a measurement chamber having a transparent member and a photodetector provided so as to face one surface of the cartridge, so as to arrange the photodetector at a plurality of positions relative to the measurement chamber; detecting, by the photodetector via the transparent member, the light emitted from the measurement sample in the measurement chamber at the plurality of positions; and detecting a foreign object in the measurement chamber based on a distribution of light amounts obtained by detecting the light at the plurality of positions; wherein the plurality of positions include: a first position for detecting, by the photodetector, light from a first region of the measurement chamber; and a second position for detecting, by the photodetector, light from a second region of the measurement chamber.

According to the present invention, it is possible to provide a sample measurement system and a sample measurement method capable of detecting a foreign object in a cartridge.

### BRIEF DESCRIPTION OF THE DRAWINGS

In FIG. 1, (A) is a side view of a measurement apparatus, (B) is a schematic plan view of a cartridge, and (C) is a view showing (B) in more detail, according to an embodiment of the present invention.

FIG. 2 is a perspective view showing a state in which a cover of the measurement apparatus is open.

FIG. 3 is a perspective view showing a state in which the cover of the measurement apparatus is closed.

FIG. 4 is a schematic view showing the internal structure of the measurement apparatus.

FIG. 5 is a block diagram showing an example of a configuration of the measurement apparatus.

FIG. 6 is a flowchart of a measurement process.

FIG. 7 is a diagram showing an example of a plurality of light detection positions.

FIG. 8 is a diagram showing an example of a plurality of light detection positions.

FIG. 9 is a diagram showing an example of a plurality of light detection positions.

FIG. 10 shows a plurality of light detection positions in the absence of a foreign object, and a light intensity graph at the plurality of light detection positions.

FIG. 11 shows a plurality of light detection positions in the presence of a foreign object, and a light intensity graph at the plurality of light detection positions.

FIG. 12 shows a plurality of light detection positions in the presence of a foreign object, and a light intensity graph at the plurality of light detection positions.

FIG. 13 is a flowchart of a foreign object detection process.

FIG. 14 is a flowchart of a foreign object detection process.

FIG. 15A to FIG. 15D show light intensity graphs at a plurality of light detection positions in the absence of a foreign object, and light intensity graphs at a plurality of light detection positions in the presence of a foreign object, prepared artificially for both cases.

FIG. 16 is a configuration diagram of a measurement system according to an embodiment of the present invention.

FIG. 17 is a block diagram showing a configuration example of the measurement system.

### DESCRIPTION OF THE EMBODIMENTS

Hereinafter, embodiments of the present invention will be described with reference to the drawings.

### First Embodiment

### 1.1 Measurement Apparatus 100

A measurement system according to a first embodiment is a measurement system including one standalone measurement apparatus. FIG. 1 shows (A) a schematic side view of a measurement apparatus, (B) a schematic plan view of a cartridge, and (C) the schematic plan view of (B) in more detail, according to the present embodiment. With reference to FIG. 1, the measurement system according to the present embodiment is described. A measurement apparatus 100 is a sample measurement apparatus that measures a measurement sample. Specifically, the measurement apparatus 100 is a sample measurement apparatus that uses a cartridge 300 to measure a measurement sample which is a liquid mixture of a sample and reagents injected into the cartridge 300. The measurement apparatus 100 is configured, for example, to perform measurement with a simple operation.

The sample is, for example, a biological sample collected from a human. The sample may be blood, urine, tissue fluid, or other body fluids. The sample can include a liquid and a solid component such as cells. The measurement of the sample includes measuring the presence or absence of a target component (a substance to be detected) according to a measurement item, the amount or concentration of the target component, and the size or shape if the target component is particulate.

The types of the reagents contained in the cartridge 300 vary depending on the measurement item. The reagents include, for example, enzymes, chemiluminescent substrates, and the like. The reagents may include a labeling substance capable of specifically binding to the target component, and a luminescent substance capable of generating chemiluminescence by reacting with the labeling substance. The reagents may include magnetic particles capable of binding to the target component. There may be variations of a plurality of types of cartridges 300 for each measurement item. The cartridge 300 may be capable of measuring a plurality of different measurement items.

The cartridge 300 is a replaceable consumable. The cartridge 300 is discarded after being used for measuring a preset number of times. The number of times the cartridge 300 can be used is one or more. The cartridge 300 is a replaceable component that consolidates required functions for detecting a substance contained in a sample.

The shape of the cartridge 300 is, for example, a flat plate shape having an internal space formed therein. The cartridge 300 includes a plurality of chambers 310 capable of accommodating a measurement sample which is a liquid mixture of a sample and reagents. The cartridge 300 includes one or a plurality of channels 330 for transferring the measurement sample between the plurality of chambers 310. The cartridge 300 is formed, for example, by bonding a transparent member to the surface of a member in which recesses constituting the chambers 310 and the channels 330 are formed to close the opening portions of the recesses, thereby forming internal spaces such as the chambers 310 and the channels 330. The internal spaces and the liquid in the spaces may be visually recognized from the outside via the transparent member. The transparent member is, for example, a transparent film.

For example, the internal space of the chamber 310 is formed by bonding the transparent member to the surface of the member of the cartridge 300 in which a hole is formed, to close the opening portions. The chamber 310 has the transparent member. The chamber 310 may or may not accommodate the reagents in advance. The reagents can be injected into the chamber 310 accommodating no reagents from another location within the cartridge 300 or from the outside of the cartridge 300. The chamber 310 is capable of accommodating a predetermined amount of liquid. The channel 330 connects between the plurality of chambers 310, and the sample can be transferred via the channel 330. The channel 330 is, for example, a channel through which liquid flows. One of the plurality of chambers 310 is a measurement chamber 316 that accommodates the measurement sample prepared from the sample and the reagents and is used for optical detection by a photodetector 31 described later. The other plurality of chambers 310 are used for preparing the measurement sample to be supplied to the measurement chamber 316.

The measurement apparatus 100 can perform various operations such as mixing of the sample and the reagents, agitation, heating or cooling, movement of solids or liquids containing a sample, and other operations inside the cartridge 300. The measurement apparatus 100 includes a cartridge holder 103 configured to detachably hold the cartridge 300.

### 1.2 Configuration of Measurement Apparatus

As shown in (A) of FIG. 1, the measurement apparatus 100 includes a rotation mechanism 10 and a measurement unit 30. The rotation mechanism 10 and the measurement unit 30 are accommodated, for example, in a housing 40 of the measurement apparatus 100.

The housing 40 is configured by a box-shaped member having an internal space of a predetermined volume, a combination of a frame and an exterior plate, or the like. The housing 40 of the measurement apparatus 100 is, for example, a small box-like shape that can be installed on a desktop.

The rotation mechanism 10 includes a rotation shaft 11 and a driver 12 such as a motor that rotationally drives the rotation shaft 11. The rotation mechanism 10 holds the cartridge 300 via the rotation shaft 11. The rotation shaft 11 is oriented in the vertical direction, for example, in the installed state of the measurement apparatus 100. The cartridge 300 is supported by the rotation mechanism 10 in an attitude along the horizontal direction. A direction of rotating around the rotation shaft 11 in a plane along the surface of the cartridge 300 is defined as a circumferential direction, and a direction of approaching toward and moving away from the rotation shaft 11 in the plane along the surface of the cartridge 300 is defined as a radial direction.

In response to rotating the rotation shaft 11 about the axis by the driver 12, the cartridge 300 rotates about the rotation shaft 11. Thereby, the chambers 310 and the channels 330 of the cartridge 300 move in the circumferential direction around the rotation shaft 11 on a circumferential trajectory having a rotation radius corresponding to the radial distance from the rotation shaft 11. The driver 12 is configured to agitate the measurement sample by moving the cartridge 300.

The rotation mechanism 10 is configured to move the chamber 310 to a light detection position by rotating the cartridge 300 about the rotation shaft 11.

The rotation mechanism 10 may be configured to perform at least a part of the measurement process by rotating the cartridge 300 about the rotation shaft 11. Thereby, not only the movement of the cartridge 300 to the light detection position but also the at least a part of the measurement process can be executed by rotating the cartridge 300 around the rotation shaft 11 using the common rotation mechanism 10.

In the present specification, the measurement process includes not only measuring the target component but also a process performed on the measurement sample in the cartridge to make the target component measurable, and can include a series of a plurality of processes until the measurement of the target component is performed.

The part of the measurement process may include at least one of a process of rotating the cartridge 300 around the rotation shaft 11 to move the measurement sample, a process of mixing the sample and the reagents to prepare the measurement sample, a process of rotating the cartridge 300 at high speed to centrifugally separate liquid components and solid components contained in the measurement sample, and a process of agitating the measurement sample by repeatedly accelerating and decelerating the rotation speed in rotating the cartridge 300.

The rotation mechanism 10 may execute at least the part of the measurement process in cooperation with other mechanisms. For example, in the process of moving the measurement sample, while rotating the cartridge 300, a magnetic force is applied by a magnet (not shown) provided in the measurement apparatus 100 so as to be located below the cartridge 300, and the target component contained in the plasma of the measurement sample in the cartridge 300 can be bound to an antibody on the surface of the magnetic particles contained in the reagent and moved. The magnet is provided in the measurement apparatus 100 so as to be movable in two directions along the vertical direction and the radial direction with respect to the cartridge 300. By moving the magnet in the radial direction, the circumferential movement caused by the rotation of the cartridge 300 and the radial movement accompanying the movement of the magnet are combined, so that the magnetic particles bound to the target component can be moved in any direction within the cartridge 300. Thereby, the target component can be efficiently taken out from the measurement sample, and a highly sensitive measurement method, for example, a highly sensitive CLEIA (Chemiluminescent Enzyme Immunoassay) can be implemented. For the movement of the target component combining the movement of the magnet and the rotation of the cartridge, reference can be made to U.S. Pat. No. 11,099,182. U.S. Pat. No. 11,099,182 is incorporated herein by reference.

The measurement unit 30 is configured to detect light emitted from the measurement sample in the measurement chamber 316 at the light detection position. The light emitted from the measurement sample includes, for example, chemiluminescence described later, and includes, for example, non-specific luminescence described later. The measurement unit 30 is configured to detect, for example, chemiluminescence, and the measurement unit 30 is configured to detect, for example, non-specific luminescence. The measurement unit 30 measures the measurement sample moved to the light detection position by the rotation of the cartridge 300 with the rotation mechanism 10. Here, the reagent in the cartridge 300 reacts with the substance in the sample to cause a change in which the substance can be directly or indirectly measured from the outside of the cartridge 300. The reagent emits light depending on the amount of the substance, for example. The luminescence is, for example, luminescence resulting from an enzymatic reaction, chemiluminescence, or the like. The reagent includes, for example, a labeling substance capable of specifically binding to the substance. The labeling substance generates a signal measurable from the outside of the cartridge 300, for example. The labeling substance includes, for example, an enzyme, a chemiluminescent substrate, and the like.

The measurement unit 30 directly or indirectly measures the light intensity emitted from the target component by detecting a change caused with the reaction between the substance in the sample and the reagent. The measurement unit 30 is disposed at a position vertically overlapping the movement path of the measurement chamber 316 caused by the rotation of the cartridge 300, for example, in order to measure the light intensity emitted from the target component in the measurement chamber 316 of the cartridge 300 supported by the rotation mechanism 10. The rotation mechanism 10 moves the measurement chamber 316 accommodating the measurement sample to the light detection position by the measurement unit 30 by rotating the cartridge 300. The measurement unit 30 measures the light intensity emitted by the measurement sample at the light detection position. The measurement unit 30 includes the photodetector 31 for measuring light intensity. The photodetector 31 includes, for example, a photomultiplier tube, a phototube, a photodiode, and the like. The photomultiplier tube is an optical sensor that achieves high sensitivity by amplifying electrons emitted by the photoelectric effect.

In sample measurement using the cartridge 300, a foreign object may be mixed in the measurement chamber 316 of the cartridge 300. For example, the foreign object may be a minute metal piece generated in the manufacturing process. The foreign object may be present in the measurement chamber 316 or on the transparent member of the measurement chamber 316.

The foreign object includes a substance capable of non-specifically reacting with the reagent in the measurement chamber 316 even though it is not an analyte to be measured. In the presence of the foreign object in the measurement chamber 316, the foreign object and the reagent may react non-specifically, and local non-specific luminescence may occur. A sudden high value may be observed as a result of local non-specific luminescence. In conventional apparatuses, it was not possible to determine whether a sudden high value was derived from a sample or a foreign object. In the present invention, it is possible to determine that a sudden high value derived from a foreign object is caused by local non-specific luminescence. In the present invention, the photodetector detects light at a plurality of light detection positions, thereby determining that the sudden high value is derived from a foreign object.

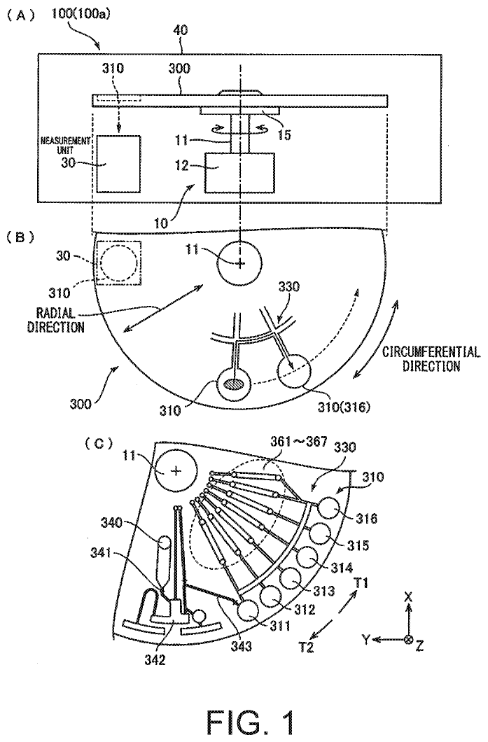

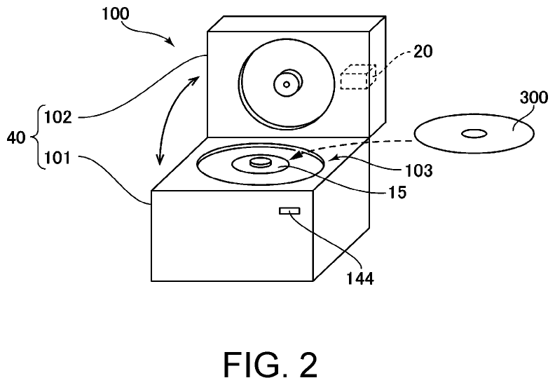

A configuration example of the measurement apparatus 100 using the cartridge 300 is described with reference to FIGS. 2 to 5. In the example shown in FIGS. 2 to 5, the measurement apparatus 100 is a measurement apparatus that detects light emitted from the measurement sample in the measurement chamber 316 by the photodetector 31 via the transparent member, and executes a process of detecting a foreign object in the measurement chamber 316 and a process of obtaining a measurement result of the target component in the measurement sample. The measurement apparatus 100 performs measurement using the cartridge 300 which is a disk-shaped cartridge.

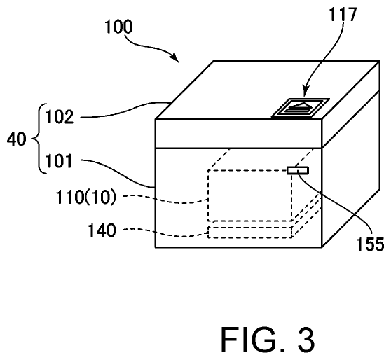

The housing 40 of the measurement apparatus 100 includes a main body 101 and a cover 102. The cover 102 is provided so as to cover substantially the upper surface of the main body 101. By adopting a structure in which the upper surface of the main body 101 is covered entirely by the cover 102, for example, external light can be blocked to make the inside of the housing 40 of the measurement apparatus 100 a dark room. The cartridge holder 103 for holding the cartridge 300 is provided on the upper surface of the main body 101. The cover 102 rotates with respect to the main body 101, and is provided so as to be openable and closable between a state in which the cartridge holder 103 is opened as shown in FIG. 2 and a state in which the cartridge holder 103 is covered with the cover 102 as shown in FIG. 3.

The measurement apparatus 100 may or may not include a display. Further, the measurement apparatus 100 may include an interface for receiving an input by an user so as to operate on a standalone basis.

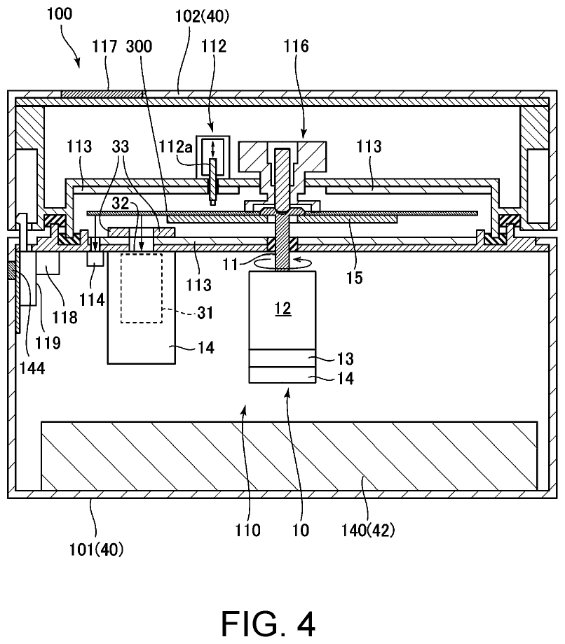

The internal structure of the measurement apparatus 100 is described with reference to FIG. 4. The measurement apparatus 100 includes a measurement mechanism 110 configured to measure the measurement sample using the cartridge 300.

The cartridge holder 103 constitutes the upper surface of the main body 101, the upper surface being covered by the cover 102 so as to be openable and closable. A support member 15 for supporting the cartridge 300 from below is disposed in the cartridge holder 103. The support member 15 may be configured by a turntable. The support member 15 is provided at an upper end of the rotation shaft 11 of the rotation mechanism 10.

In the example of FIG. 4, the measurement mechanism 110 includes the rotation mechanism 10, an opening unit 112, a heater 113 and a temperature sensor 114, and the measurement unit 30.

The rotation mechanism 10 includes the rotation shaft 11 and the driver 12 including a motor. The rotation mechanism 10 drives the driver 12 to rotate the cartridge 300 installed on the support member 15 around the rotation shaft 11. The rotation mechanism 10 includes an encoder 13 for detecting a rotation angle of the driver 12, and an origin sensor 14 for detecting an origin position of the rotation angle. Based on the detection position by the origin sensor 14, the driver 12 is driven based on the detection angle of the encoder 13, whereby the cartridge 300 is movable to an arbitrary rotation position. For example, the photodetector 31 of the measurement unit 30 is configured to be moved and arranged at a plurality of positions on one side of the cartridge 300.

In the example of FIG. 4, the rotation mechanism 10 is configured to perform at least a part of the measurement process by rotating the cartridge 300 about the rotation shaft 11. As described later, the rotation mechanism 10 performs processes such as centrifugation of the sample, transfer of the sample, and agitation of the sample and the reagents inside the cartridge 300 by rotation as part of the measurement process.

The opening unit 112 projects a pin member 112a configured to advance and retreat toward the cartridge 300 from above the cartridge 300 arranged in the cartridge holder 103 to abut against the cartridge 300, and opens a sealing body in the cartridge 300 by pressing the sealing body. After opening, the opening unit 112 moves the pin member 112a to a retracted position separated from the cartridge 300 and out of contact therewith.

The heaters 113 are provided at a position immediately below the cartridge 300 arranged in the cartridge holder 103 and a position immediately above the cartridge 300, respectively. The heater 113 heats the measurement sample contained in the chamber 310 to a predetermined reaction temperature to promote a reaction between the sample and the reagent. The temperature sensor 114 detects the temperature of the cartridge 300 by infrared radiation.

The measurement unit 30 includes the photodetector 31 provided so as to face one surface of the cartridge 300 held by the cartridge holder 103 and configured to detect light emitted from the measurement sample moved to the light detection position via the transparent member. The photodetector 31 is provided at a position facing the cartridge 300 arranged in the cartridge holder 103 via an opening formed in the main body 101. The photodetector 31 includes a light receiving part 32, and the light receiving part 32 receives light emitted according to the amount of the target component of the measurement sample moved to the light detection position. The light emitted from the measurement sample is, for example, light generated by chemiluminescence, light emitted during an enzymatic reaction, or the like. The photodetector 31 is configured by, for example, a photomultiplier tube, a phototube, a photodiode, or the like. The photodetector 31 outputs a pulse waveform corresponding to the reception of photons.

The photodetector 31 may include a hollow member. Thereby, the light emitted from the measurement sample can be collected in the light receiving part 32. The hollow member is configured to restrict detection of light from an unintended direction by the light receiving part 32 by restricting the progress of light other than the light emitted from the measurement sample. The hollow member is, for example, a frame 33 provided around the light receiving part 32.

The measurement unit 30 includes a circuit therein, counts photons at regular intervals based on the output signal of the photodetector 31, and outputs a count value. By rotating the cartridge 300 and moving the measurement sample to the light detection position, the measurement result can be easily obtained by optical measurement. Since optical measurement can be performed in a non-contact manner by the photodetector 31, it is not necessary to enlarge the apparatus configuration upon adopting the measurement apparatus 100 using the cartridge 300.

The measurement apparatus 100 includes a clamper 116. The clamper 116 rotatably supports the central portion of the upper surface of the cartridge 300 installed on the support member 15 in a state where the cover 102 is closed. The cartridge 300 is supported while being sandwiched between the support member 15 and the clamper 116. The clamper 116 is configured to be vertically strokable within a predetermined range, and is biased toward the support member 15 side. The clamper 116 is provided with a stroke detection sensor (not shown), which is connected to a controller 140 described later. Based on the difference in the stroke amount of the clamper 116, it is possible to detect a state in which the cartridge 300 is not installed, a state in which the cartridge 300 is properly installed, and a state in which the cartridge 300 is installed but is improper caused by misalignment or the like.

In addition, as shown in FIG. 4, the measurement apparatus 100 includes an operation unit 117 (see FIG. 3) that receives a user's operation for opening the cover 102, a detector 118 that detects opening and closing of the cover 102, a lock mechanism 119 that engages with the cover 102 in the closed state to lock the cover 102, and the like. The cover 102 is biased in the opening direction by a biasing member (not shown). Upon release of the lock of the lock mechanism 119 of the cover 102 in the closed state, the cover 102 is opened by the biasing force and held in the open state.

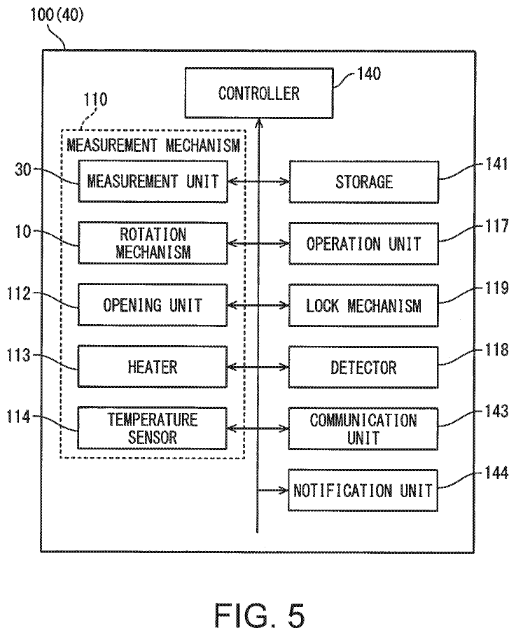

FIG. 5 is a block diagram showing a configuration example of the measurement apparatus.

The measurement apparatus 100 includes the controller 140. The controller 140 includes, for example, a processor and a memory. The processor is configured by, for example, a CPU, an MPU, or the like. The memory is configured by, for example, a ROM, a RAM, or the like. The controller 140 receives signals from each part of the measurement apparatus 100 and controls each part of the measurement apparatus 100.

The measurement apparatus 100 includes a storage 141. The storage 141 stores at least information such as measurement results. The storage 141 is configured by, for example, a flash memory, a hard disk, or the like.

The measurement apparatus 100 includes a communication unit 143. The communication unit 143 is capable of transmitting information to an external device and receiving information from an external device. The communication unit 143 includes, for example, a communication module, an interface for external connection, and the like. The communication unit 143 may be capable of communication by a plurality of types of communication methods. The connection to the network includes, for example, connection by wired LAN, wireless LAN, or the like.

Returning to FIG. 4, the measurement apparatus 100 includes a notification unit 144 (see FIG. 2) capable of notifying the state of the apparatus by a method different from a screen display. The notification unit 144 notifies the state of the apparatus by at least one of light color, illumination, flashing of light, light blinking, sound, information transmission to a terminal, and the like. That is, the notification unit 144 may include indicator that notifies by light emission, or a speaker or buzzer that notifies by sound. The notification unit 144 may be a communication module or an external connection interface having the same configuration as the communication unit 143. By providing the notification unit 144, it is possible to notify a state that is easily recognizable to the user without using the display screen.

### 1.3 Foreign Object Detection Process and Measurement Result Acquisition Process

The measurement process according to an embodiment of the present invention includes a foreign object detection process and a measurement result acquisition process. The foreign object detection process and the measurement result acquisition process are described. The measurement apparatus 100 according to the present embodiment includes the cartridge holder 103 configured to detachably hold the cartridge 300 capable of accommodating the measurement sample which is a liquid mixture of a sample and reagents. The measurement apparatus 100 according to the present embodiment includes the photodetector 31 provided so as to face one surface of the cartridge 300 held by the cartridge holder 103 and configured to detect, via the transparent member, light emitted from the measurement sample according to an amount of a target component in the measurement sample, the driver 12 configured to move at least one of the cartridge 300 held by the cartridge holder 103 and the photodetector 31, and the controller 140 configured to obtain a measurement result of the target component based on the light detected by the photodetector 31. In the measurement apparatus 100 according to the present embodiment, the controller 140 controls the driver to arrange the photodetector 31 at a plurality of positions relative to the measurement chamber 316 by moving the at least one of the cartridge 300 and the photodetector 31. Then, the controller 140 causes the photodetector 31 to detect the light emitted from the measurement sample in the measurement chamber 316. Based on the light detected at the plurality of positions, the controller 140 detects a foreign object in the measurement chamber 316. Here, the at least one of the plurality of positions may be a position where the photodetector 31 receives a part of the light emitted from the measurement sample toward one side of the cartridge 300. At least two of the plurality of positions may be positions where the photodetector 31 receives a part of the light emitted from the measurement sample toward one surface of the cartridge 300. At least another one of the plurality of positions may be a position where the photodetector 31 receives all of the light emitted from the measurement sample toward one surface of the cartridge 300. The controller 140 may obtain the measurement result of the target component in the measurement sample based on the light detected by the photodetector 31 at the position where the photodetector 31 receives all of the detected light. The controller 140 may detect the foreign object in the measurement chamber 316 based on the light detected by the photodetector 31 at the position where the photodetector 31 receives a part of the light.

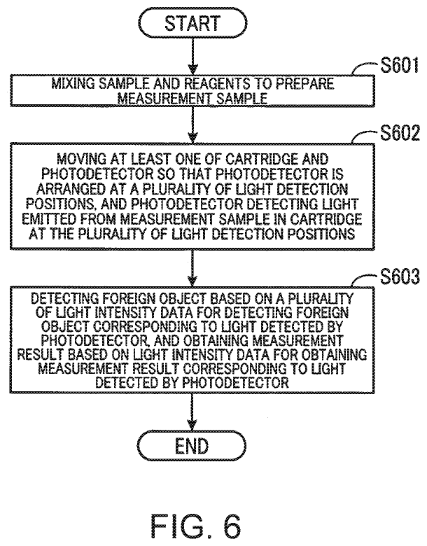

As shown in the flowchart of FIG. 6, the measurement process includes step S601, step S602, and step S603.

In step S601, the sample and the reagents are mixed to prepare the measurement sample. (C) of FIG. 1 is a view showing the schematic plan view of the cartridge 300 of (B) of FIG. 1 in more detail. The operation of the measurement apparatus 100 in step S601 is described after describing the configuration of the cartridge 300 with reference to (C) of FIG. 1.

In addition to the chambers 310 and the channels 330 shown in FIG. 1, the cartridge 300 includes a sample well 340 for receiving a sample, and a separation unit 342 configured to separate components of the sample.

The chambers 310 include six chambers: a first chamber 311 to a sixth chamber 316. Each chamber is connected to an adjacent chamber via the channel 330. The cartridge 300 further includes seven liquid containing parts 361 to 367 inside each chamber in the radial direction. The seven liquid containing parts include a first liquid accommodating part 361, a second liquid accommodating part 362, a third liquid accommodating part 363, a fourth liquid accommodating part 364, a fifth liquid accommodating part 365, a sixth liquid accommodating part 366, and a seventh liquid accommodating part 367 in the order from the T2 direction to the T1 direction. The first liquid accommodating part 361 accommodates an R1 reagent. The R1 reagent includes, for example, first antibodies that bind to the target components. The antibodies are modified with biotins to bind to magnetic particles contained in an R2 reagent described later.

The first chamber 311 accommodates the R2 reagent. The R2 reagent includes, for example, magnetic particles and a magnetic particle suspension. The magnetic particles are, for example, streptavidin magnetic particles whose surfaces are coated with avidin.

The second liquid accommodating part 362 accommodates an R3 reagent. The R3 reagent is, for example, a second antibody that binds to the target component. The second antibody is labeled with labeling substances such as alkaline phosphatase (ALP).

The third liquid accommodating part 363 to the fifth liquid accommodates part 365 accommodate a washing liquid.

The sixth liquid accommodating part 366 accommodates an R4 reagent. The R4 reagent is a reagent for dispersing a complex. The R4 reagent is, for example, a buffer solution.

The seventh liquid accommodating part 367 accommodates an R5 reagent. The R5 reagent is a luminescent reagent containing chemiluminescent substrates that generate light by reacting with a labeled antibody bound to the complex.

Preparation of the measurement sample using the cartridge 300 is described. First, the sample is dispensed into the sample well 340. The sample is, for example, whole blood. The dispensed sample is transferred to the separation unit 342 via the channel 341. The measurement apparatus 100 rotates the cartridge 300 at high speed to separate the whole blood accommodated in the separation unit 342 into a plasma component and a blood cell component. The separated plasma component is transferred to the first chamber 311 via the channel 343.

The measurement apparatus 100 supplies the R1 reagent from the first liquid accommodating part 361 to the first chamber 311. In the first chamber 311, the plasma component, the R1 reagent, and the R2 reagent are mixed. The measurement apparatus 100 agitates the liquid in the first chamber 311 by rotating the cartridge 300. The rotation for agitation may be, for example, repeated forward and reverse rotations, rotation repeating acceleration and deceleration, or intermittent rotation. For example, the forward and reverse rotations repeatedly apply centrifugal force and inertial force to the liquid in the first chamber 311 by repeating the forward rotation in the T1 direction and the reverse rotation in the T2 direction in a short time. The liquid in the first chamber 311 is mixed by agitation, and the target components and the first antibodies contained in the R1 reagent bind by an antigen-antibody reaction. Further, the first antibodies and the magnetic particles bind by biotin-avidin binding. As a result, a complex in which the target components are bound to the magnetic particles via the first antibodies is formed.

The measurement apparatus 100 attracts the complex with the magnet, and transfers the complex from the first chamber 311 to the second chamber 312 by combining the movement of the magnet and the rotation of the cartridge 300. The measurement apparatus 100 supplies the R3 reagent from the second liquid accommodating part 362 to the second chamber 312. In the second chamber 312, the complex and the R3 reagent are mixed. The measurement apparatus 100 agitates the liquid in the second chamber 312 by rotating the cartridge 300. By agitation, the complex reacts with the second antibodies contained in the R3 reagent. As a result, a complex in which the target components, the first antibodies, the magnetic particles, and the second antibodies are bound is formed.

In the same manner as described above, the measurement apparatus 100 transfers the complex to the third chamber 313 by a combination of the movement of the magnet and the rotation of the cartridge 300. The measurement apparatus 100 supplies the washing liquid accommodated in the third liquid accommodating part 363 to the third chamber 313. The measurement apparatus 100 washes the complex in the third chamber 313 with the washing liquid by rotating the cartridge 300. The measurement apparatus 100 repeatedly performs this operation in the fourth chamber 314 and the fifth chamber 315 to remove unreacted components.

The measurement apparatus 100 supplies the R4 reagent contained in the sixth liquid accommodating part 366 to the sixth chamber 316. Further, the measurement apparatus 100 transfers the complex in the fifth chamber 315 to the sixth chamber 316. The measurement apparatus 100 performs agitation by rotating the cartridge 300. Thereby, in the sixth chamber 316, the complex and the R4 reagent are mixed, and the complex is dispersed in the liquid.

In a state where the complex is dispersed, the measurement apparatus 100 supplies the R5 reagent accommodated in the seventh liquid accommodating part 367 to the sixth chamber 316. By the measurement apparatus 100 rotating the cartridge 300 for agitation, the complex, the R4 reagent (dispersion liquid), and the R5 reagent (luminescent substrate) are mixed in the sixth chamber 316. The mixture of the complex, the dispersion liquid, and the luminescent substrates prepared in this manner is referred to as the measurement sample. Upon the reaction of the labeling substances bound to the complex in the measurement sample with the luminescent substrates, chemiluminescence occurs. Since the complex and the luminescent substrates in the measurement sample in the sixth chamber 316 are dispersed by agitation, the concentration in the chamber is made uniform. Therefore, if no foreign object is mixed in the sixth chamber 316, theoretically, the intensity of chemiluminescence is uniform in the chamber. As described later, in the foreign object detection process, the controller 140 detects a foreign object based on the non-uniformity of the distribution of light amounts, based on the distribution of light amounts by chemiluminescence detected at a plurality of positions.

Referring back to the flowchart of FIG. 6, in step S602, at least one of the cartridge 300 and the photodetector 31 is moved so that the photodetector 31 is arranged at a plurality of light detection positions, and the photodetector 31 detects light emitted from the measurement sample in the cartridge 300 at the plurality of light detection positions. In the present embodiment, the cartridge 300 is moved.

In step S603, the foreign object detection process of detecting a foreign object based on multiple light intensity data for foreign object detection corresponding to the light detected by the photodetector 31, and a measurement result acquisition process of obtaining a measurement result based on light intensity data for measurement result acquisition corresponding to the light detected by the photodetector 31 are performed. The light detection position is the position of the photodetector 31 relative to the measurement chamber 316 of the cartridge 300. The light detection position may include a measurement position which is the position of the photodetector 31 for obtaining the light intensity data for the measurement result acquisition. In this specification, light intensity data based on light detected at a position where the photodetector 31 receives a portion of the light emitted from the measurement sample toward one side of the cartridge 300 may be expressed as “light intensity data for foreign object detection”. In addition, in this specification, light intensity data based on light detected at a position where the photodetector 31 receives all of the light emitted from the measurement sample toward one side of the cartridge 300 may be expressed as “light intensity data for measurement result acquisition”.

As described above, according to the present embodiment, by rotating the cartridge 300 around the rotation shaft 11, the measurement sample in the cartridge 300 is arranged at a plurality of light detection positions. As described above, at least a part of the measurement process may be executed by rotating the cartridge 300 around the rotation shaft 11. Thereby, not only the movement to the light detection positions but also at least a part of the measurement process is performed by rotating the cartridge 300 around the rotation shaft 11.

A measurement apparatus 100a according to a modification of the measurement apparatus 100 includes a rotation mechanism 10 and a measurement unit 30. The rotation mechanism 10 is configured to rotate a photodetector 31 around a rotation shaft 11 such that at least part of a measurement process is executed. The cartridge 300 includes a plurality of chambers 310 capable of accommodating a measurement sample, which is a liquid mixture of a sample and reagents, and a channel 330 for transferring the measurement sample between the plurality of chambers 310. The measurement unit 30 measures the measurement sample moved to light detection positions by rotating the photodetector 31 with the rotation mechanism 10.

Similarly, the measurement process according to the modification is a method of measuring a measurement sample using the cartridge 300 including a plurality of chambers 310 configured to accommodate a measurement sample which is a liquid mixture of a sample and reagents and a channel 330 for transferring the measurement sample between the plurality of chambers 310, the method including the following steps. In step S601, the sample and the reagents are mixed to prepare the measurement sample. In step S602, at least one of the cartridge 300 and the photodetector 31 is moved so that the photodetector 31 is arranged at a plurality of light detection positions, and the photodetector 31 detects light emitted from the measurement sample in the cartridge 300 at the plurality of light detection positions. In this modification, the photodetector 31 is moved. In step S603, the foreign object detection process of detecting a foreign object based on multiple light intensity data for foreign object detection corresponding to the light detected by the photodetector 31, and a measurement result acquisition process of obtaining a measurement result based on light intensity data for measurement result acquisition corresponding to the light detected by the photodetector 31 are performed.

As described above, according to this modification, by rotating the photodetector 31 around the rotation shaft 11, the measurement sample in the cartridge 300 can be arranged at a plurality of light detection positions. As described above, at least a part of the measurement process may be executed by rotating the photodetector 31 around the rotation shaft 11. Thereby, not only the movement to the light detection position but also at least a part of the measurement process is performed by rotating the photodetector 31 around the rotation shaft 11.

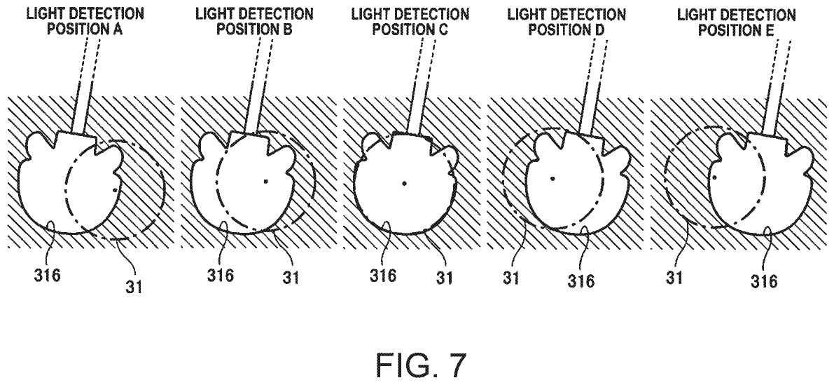

FIGS. 7 to 9 are diagrams showing examples of light detection positions where the photodetector detects light at a plurality of positions during measurement of the measurement sample. The plurality of light detection positions during the measurement is described with reference to FIGS. 7 to 9. Here, the cover 102 side of the measurement apparatus 100 in FIG. 3 is defined as an upper side, the main body 101 side is defined as a lower side. For example, (B) of FIG. 1 is a top view, and similarly, FIGS. 7 to 9 are top views.

The plurality of positions include a first position where the photodetector 31 detects light emitted from a first region of the measurement chamber 316 and a second position where the photodetector 31 detects light emitted from a second region of the measurement chamber 316. The first region and the second region are regions where the measurement chamber 316 overlaps with a detection surface of the photodetector 31. The first region is, for example, a region including a part of the measurement chamber 316. The second region is, for example, a region encompassing the first region. The second region is, for example, a region corresponding to a wider range of the measurement chamber 316 than the first region. The second region is, for example, a region covering the measurement chamber 316 more widely than the first region. At the first position, light may be detected by the photodetector 31 for detection of a foreign object. At the second position, light may be detected by the photodetector 31 for detection of a foreign object. At the second position, light may be detected by the photodetector 31 for acquisition of a measurement result.

FIG. 7 shows the light detection positions A to E, which are a plurality of positions during the measurement of the measurement sample, respectively, and shows a positional relationship between the region of the measurement chamber 316 and the region of the detection surface of the photodetector 31 at each light detection position. Each of the light detection positions A to E is a specific position in which the photodetector 31 is capable of detecting light emitted from the measurement sample in the measurement chamber 316. Each of the light detection positions A to E corresponds to a region, among the light emitted from the measurement sample in the measurement chamber 316, that is at least partially different from one another. The light detection position C is a position where the center of the detection surface of the photodetector 31 coincides with the center of the measurement chamber 316. The light detection position C is a position where the region of the measurement chamber 316 is equal to the region of the detection surface of the photodetector 31 in a top view. The light detection position C may be a position where the photodetector 31 receives all of the light emitted from the measurement sample toward one side of the cartridge 300. For example, the light detection position C may be a measurement position which is the position of the photodetector 31 for obtaining the light intensity data for acquiring the measurement result. The light detection positions A, B, D, and E are positions capable of detecting a plurality of different regions that are separated from the center of the measurement chamber 316 along the circumferential direction of the cartridge 300. At the light detection positions A and B, light is detected from different regions separated from the center of the measurement chamber 316 along one circumferential direction of the cartridge 300. At the light detection positions D and E, the light is detected from different regions separated from the center of the measurement chamber 316 along the opposite circumferential direction of the cartridge 300. The light detection positions A, B, D, and E may be the first position where the photodetector 31 detects light emitted from the first region of the measurement chamber 316. The light detection position C may be the second position where the photodetector 31 detects light emitted from the second region of the measurement chamber 316.

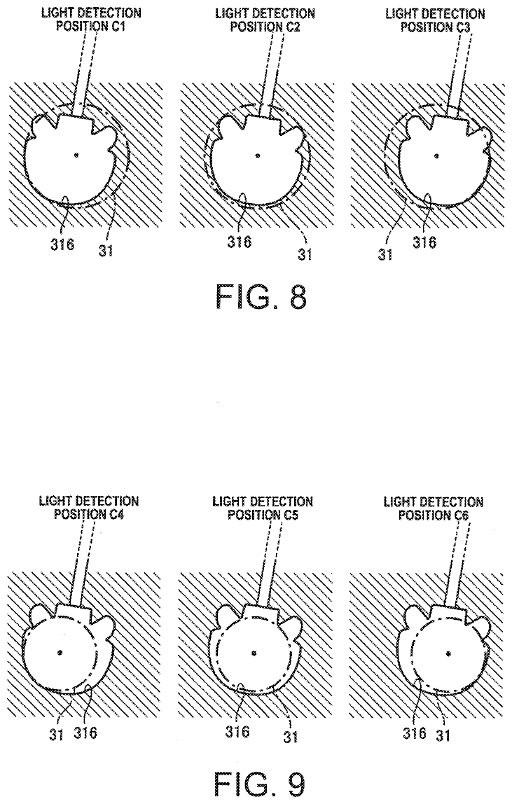

The configuration of the light detection position C may be different from the case shown in FIG. 7. For example, a size of the region of the measurement chamber 316 and a size of the region of the detection surface of the photodetector 31 are different from each other in top view. In such case, the region of the measurement chamber 316 and the detection surface of the photodetector 31 may not be equal in the top view, even at a position where the center of the measurement chamber 316 coincides with the center of the detection surface. FIGS. 8 and 9 show such a case. FIG. 8 shows a case where the region of the measurement chamber 316 is smaller than the region of the detection surface of the photodetector 31 in the top view. At light detection position C2, although the center of the measurement chamber 316 coincides with the center of the detection surface of the photodetector 31, the region of measurement chamber 316 is not equal to the region of the detection surface of the photodetector 31 in the top view because the region of measurement chamber 316 is smaller than the region of the detection surface of the photodetector 31. At each of light detection positions C1 to C3, the detection surface of the photodetector 31 encompasses the region of the measurement chamber 316 in the top view. FIG. 9 shows a case where the region of the detection surface of the photodetector 31 is smaller than the region of the measurement chamber 316 in the top view. At light detection position C5, although the center of the measurement chamber 316 coincides with the center of the detection surface of the photodetector 31, the detection surface of the photodetector 31 is not equal to the region of the measurement chamber 316 in the top view because the region of the detection surface of the photodetector 31 is smaller than the region of the measurement chamber 316. At each of light detection positions C4 to C6, the region of the detection surface of the photodetector 31 is encompassed in the region of the measurement chamber 316 in the top view.

At least one of the cartridge 300 and the photodetector 31 is moved so that the photodetector 31 is arranged at each of the light detection positions A to E. At each of the light detection positions A to E, the photodetector 31 detects light generated by chemiluminescence emitted from the measurement sample in the cartridge 300 and obtains multiple light intensity data for detecting a foreign object. Further, at any of the light detection positions A to E, the photodetector 31 is capable of obtaining light intensity data for acquiring the measurement result by detecting light generated by chemiluminescence emitted from the measurement sample in the cartridge 300. For example, at the light detection position C, the photodetector 31 is capable of detecting light emitted from the measurement sample in the cartridge 300 to obtain light intensity data for the measurement result.

In the case of FIG. 7, the light intensity data for the measurement result acquisition may be the light intensity data for the foreign object detection corresponding to the light detected by the photodetector 31 at the light detection position C among the multiple light intensity data for the foreign object detection obtained at the light detection positions A to E. In the case of FIG. 8, the light intensity data for the measurement result acquisition may be the light intensity data for the foreign object detection corresponding to the light detected by the photodetector 31 at any of the light detection positions C1 to C3 among the multiple light intensity data for the foreign object detection obtained at the plurality of light detection positions. In the case of FIG. 9, the light intensity data for the measurement result acquisition may be the light intensity data for the foreign object detection corresponding to the light detected by the photodetector 31 at any of the light detection positions C4 to C6 among the multiple light intensity data for the foreign object detection obtained at the plurality of light detection positions.

The controller 140 detects a foreign object in the measurement chamber 316 based on a distribution of light amounts caused by chemiluminescence detected at a plurality of positions. For example, the foreign object is detected based on non-uniformity of the distribution of light amounts. For example, the foreign object is detected based on detection of an increase in light amounts localized in the first region of the measurement chamber 316. For example, it is determined whether or not the foreign object exists based on a degree of similarity between the obtained light intensity data for the foreign object detection and reference data generated based on light intensity data in absence of the foreign object.

The controller 140 may control the driver to disperse the target component contained in the measurement sample within the measurement chamber 316 by agitating the measurement sample before obtaining the measurement result and detecting the foreign object. The controller 140 may control the driver 12 to disperse magnetic particles bound to the target component contained in the measurement sample within the measurement chamber 316 by agitating the measurement sample before obtaining the measurement result and detecting the foreign object.

The light intensity data for the foreign object detection at each of the light detection positions A to E used for the foreign object detection process may be, for example, measurement data itself at each of the light detection positions A to E. The light intensity data for the foreign object detection at each of the light detection positions A to E used for the foreign object detection process may be obtained by performing a predetermined calculation process on the measurement data at each of the light detection positions A to E. The light intensity data for the foreign object detection at each of the light detection positions A to E used for the foreign object detection process may be obtained by normalizing measurement data at each of the light detection positions A to E as a relative value with respect to measurement data at the light detection position C.

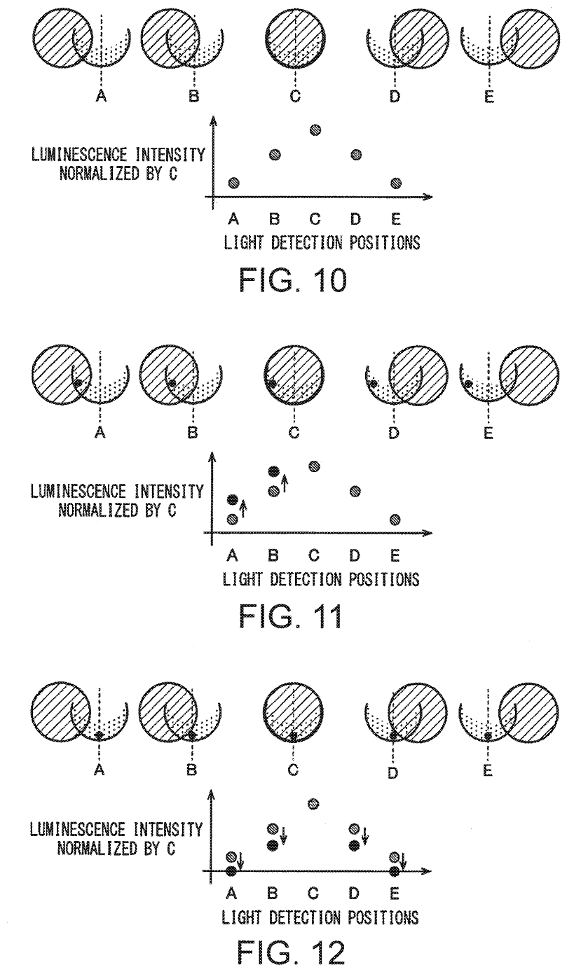

FIGS. 10 to 12 show the positional relationship between the region of the measurement chamber 316 and the region of the detection surface of the photodetector 31 at each light detection position of the light detection positions A to E, which are a plurality of light detection positions during the measurement of the measurement sample, and the light intensity data for the foreign object detection obtained at each light detection position. The light intensity data for the foreign object detection at each light detection position shown in FIGS. 10 to 12 are obtained by normalizing light intensity data measured at each light detection position as a relative value with respect to light intensity data measured at the light detection position C. FIG. 10 shows a case where no foreign object exists, and FIGS. 11 and 12 show a case where a foreign object exists. In this specification, the case where no foreign object exists as shown in FIG. 10 may be expressed as “normal”, “normal luminescence”, “normal state”, or the like, and the case where a foreign object exists as shown in FIGS. 11 and 12 may be expressed as “abnormal”, “abnormal luminescence”, “abnormal state”, or the like.

Referring to FIG. 10, at the light detection position C among the light detection positions A to E, the overlap between the region of the measurement chamber 316 and the region of the detection surface of the photodetector 31 is maximum. Therefore, the detected light intensity is the maximum light intensity. The overlap at the light detection positions B and D is smaller than that at the light detection position C. Accordingly, the detected light intensity at the light detection positions B and D is smaller than that at the light detection position C. The overlap at the light detection positions A and E is smaller than that at the light detection positions B and D. Accordingly, the detected light intensity is smaller than that at the light detection positions B and D. Therefore, by normalizing the light intensity data for the foreign object detection at each of the other light detection positions with the light intensity data for the foreign object detection at the light detection position C, the normalized light intensity is maximum at the light detection position C. The normalized light intensities at the light detection positions B and D are smaller than that at the light detection position C. Furthermore, the normalized light intensities at the light detection positions A and E are smaller than those at the light detection positions B and D. As a result, a graph as shown in FIG. 10 is obtained.

Referring to FIG. 11, a foreign object exists in a region where the region of the measurement chamber 316 and the region of the detection surface of the photodetector 31 overlap at the light detection position A, B, and C. Therefore, at the light detection position A, B, and C, the light intensity of luminescence by the foreign object is added to the light intensity of normal luminescence as the detected light intensity. As described above, since the overlap between the region of the measurement chamber 316 and the region of the detection surface of the photodetector 31 decreases in the order of the light detection position C, B, and A, the light intensity of normal luminescence decreases in this order. Therefore, the light intensity of luminescence by the foreign object becomes relatively larger than the light intensity of normal luminescence in this order. By normalizing the light intensity data for the foreign object detection at the light detection positions A and B with the light intensity data for the foreign object detection at the light detection position C, the normalized light intensities at the light detection positions A and B is larger than in the case of normal luminescence. For comparison, the light intensity data for the foreign object detection of normal luminescence in FIG. 10 is superimposed on FIG. 11. As indicated by arrows, it can be seen that the normalized light intensities at the light detection positions A and B are larger than in the case of normal luminescence.

Referring to FIG. 12, a foreign object exists in a region where the region of the measurement chamber 316 and the region of the detection surface of the photodetector 31 overlap at the light detection position C. At the light detection position C, similarly to the case of FIG. 11 described above, the light intensity of luminescence by the foreign object is added to the light intensity of normal luminescence as the detected light intensity. Therefore, the light intensity at the light detection position C becomes larger than the light intensity at the light detection position C in the case of normal luminescence by the amount of the added light intensity of luminescence with the foreign object. By normalizing the light intensity data for the foreign object detection at each of the other light detection positions with such light intensity data for the foreign object detection at the light detection position C, the normalized light intensity at each of the other light detection positions is smaller than in the case of normal luminescence. For comparison, the light intensity data for the foreign object detection of normal luminescence in FIG. 10 is superimposed on FIG. 12. As indicated by arrows, it can be seen that the normalized light intensities at the light detection positions A, B, D, and E are smaller than in the case of normal luminescence.

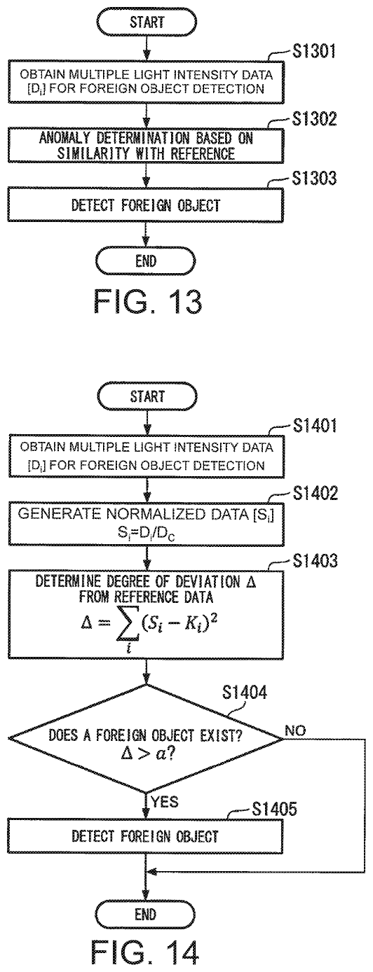

As shown in the flowchart of FIG. 13, the foreign object detection process includes step S1301, step S1302, and step S1303. In step S1301, multiple light intensity data for the foreign object detection Dᵢ is obtained. “i” indicates a light detection position, for example, A, B, C, D, or E. For example, light intensity data for the foreign object detection D_{A} at the light detection position A is obtained. In step S1302, it is determined whether or not a foreign object exists based on a degree of similarity between the light intensity data for the foreign object detection obtained in step S1301 and reference data. In addition, it may be determined whether or not a foreign object exists based on a degree of deviation instead of the degree of similarity. In step S1303, the foreign object is detected.

As shown in the flowchart of FIG. 14, the foreign object detection process includes step S1401, step S1402, step S1403, step S1404, and step S1405. Here, an example using a degree of deviation is described. In step S1401, multiple light intensity data for foreign object detection Dᵢ are obtained. “i” indicates a light detection position, for example, A, B, C, D, or E. For example, light intensity data for foreign object detection D_{A} at the light detection position A is obtained. In step S1402, normalized data Sᵢ is generated based on the light intensity data for the foreign object detection Dᵢ obtained in step S1401. The generation of the normalized data Sᵢ of the light intensity data for the foreign object detection Dᵢ at the light detection position i is performed. For example, by dividing the light intensity data for the foreign object detection Dᵢ by the light intensity data for foreign object detection D_{C} at the light detection position C. For example, normalized data S_{A} of the light intensity data for the foreign object detection D_{A} at the light detection position A is generated from S_{A}=D_{A}/D_{C} using the light intensity data for the foreign object detection D_{A} and D_{C} at the light detection positions A and C. In step S1403, a degree of deviation “Δ” indicating a degree of deviation between the normalized data generated in step S1402 and reference data is determined. The degree of deviation is determined from the following Formula 1 using the normalized data Sᵢ and reference data Kᵢ at the light detection position i. The reference data Kᵢ is generated based on light intensity data at the light detection position i where no foreign object exists, which is obtained in advance, and is set in advance.

$$Δ = {\sum }_{i} {( {S}_{i} - {K}_{i} )}^{2} \qquad [ Formula 1 ]$$

In step S1404, it is determined whether or not a foreign object exists. The determination of whether or not a foreign object exists may be made based on the degree of deviation determined in step S1403. For example, if the determined degree of the deviation Δ is larger than a preset threshold a, it may be determined that a foreign object exists, while if the determined degree of deviation is equal to or smaller than the preset threshold a, it may be determined that no foreign object exists. If it is determined in step S1404 that a foreign object exists, the foreign object is detected in step S1405. Alternatively, for example, the determination can be made using a degree of similarity, which is the reciprocal of the degree of the deviation Δ.

The determination of whether or not a foreign object exists in step S1404 is not limited to the above. For example, the determination may be made based on a degree of deviation obtained by comparing between a relationship between the light intensity data for the foreign object detection detected at the light detection position C and the light intensity data for the foreign object detection detected at the light detection positions A, and a relationship between the reference data at the light detection position C and the reference data at the light detection position A. For example, the determination may be made based on a degree of deviation between a ratio of measurement values at two or more light detection positions and a ratio of values of reference data at the same light detection positions. For example, using the light intensity data for the foreign object detection Dᵢ at the light detection position i, the determination may be made based on the formula Kᵢ−σᵢ≤Dᵢ/D_{C}≤Kᵢ+σᵢ. For example, if this formula is not satisfied at any light detection position i, it may be determined that a foreign object exists. If this formula is satisfied at all light detection positions i, it may be determined that no foreign object exists. The reference data Kᵢ is generated based on light intensity data at the light detection position i where no foreign object exists, which is obtained in advance, “σᵢ” is a threshold, and “Kᵢ” and “σᵢ” are set in advance.

Further, the determination of whether or not a foreign object exists may be performed by storing a trained model trained using, as training data, light intensity data labeled as a normal state and an abnormal state. The abnormal state is a state in which the foreign object is detected, so as to output detection of the foreign object for multiple light intensity data for the foreign object detection. The determination is performed based on the multiple light intensity data for the foreign object detection and the trained model.

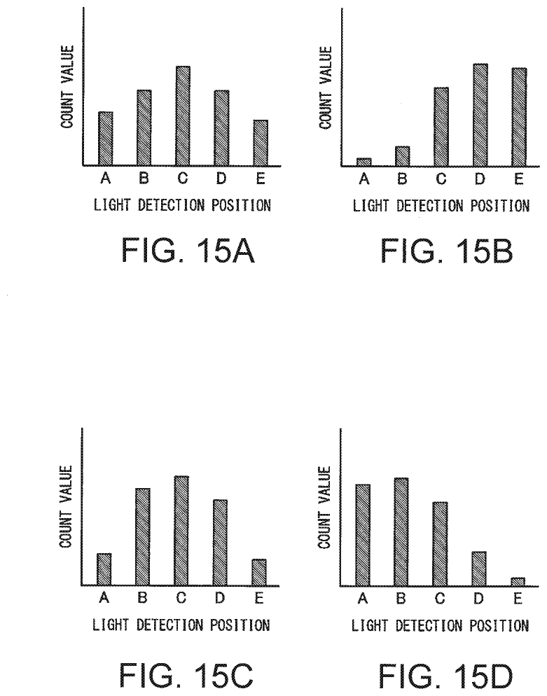

FIG. 15A to FIG. 15D show light intensity graphs at a plurality of light detection positions A to E in absence of a foreign object and in presence of a foreign object, prepared artificially in the measurement chamber 316. FIG. 15A shows light intensity graphs at the plurality of light detection positions A to E in the absence of a foreign object. Regarding the case where a foreign object exists, three patterns are prepared by changing the location where the foreign object exists in the measurement chamber 316. FIG. 15B to FIG. 15D show light intensity graphs at the plurality of light detection positions A to E with a foreign object artificially arranged at one end, the center, and at the other end of the measurement chamber 316, respectively. The vertical axes of these graphs are count values obtained by counting photons at regular intervals based on the output signal of the photodetector 31, and the horizontal axes are light detection positions. The scales of the vertical axes of these graphs may not necessarily be common.

The determination of whether or not a foreign object exists was made based on the formula Kᵢ−σᵢ≤Dᵢ/D_{C}≤Kᵢ+σᵢ using the light intensity data for the foreign object detection Dᵢ at the light detection position i among several methods described above. If this formula was not satisfied at any light detection position i, it was determined that a foreign object existed. If this formula was satisfied at all light detection positions i, it was determined that no foreign object existed. By such determination of whether or not a foreign object exists, it was determined that no foreign object existed in FIG. 15A. On the other hand, it was determined that a foreign object existed in FIG. 15B, FIG. 15C, and FIG. 15D.

In the measurement result acquisition process, in response to detecting the foreign object in the measurement chamber, the controller 140 may add identification information indicating detection of the foreign object to the information of the measurement result. Such addition of the identification information may be any method as long as it can be recognized that the foreign object has been detected, for example, setting a flag indicating that the foreign object has been detected.

### Second Embodiment

A second embodiment is described below. The second embodiment is different from the first embodiment which is the measurement system including one standalone measurement apparatus. The second embodiment is a measurement system including the measurement apparatus and a server apparatus as described later. Other points are the same as those of the first embodiment. For simplification of description, only points different from the first embodiment is described below.

### 2.1 Measurement System 200

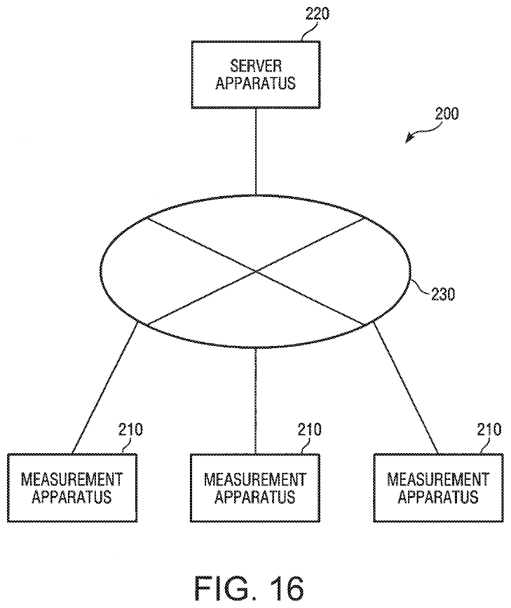

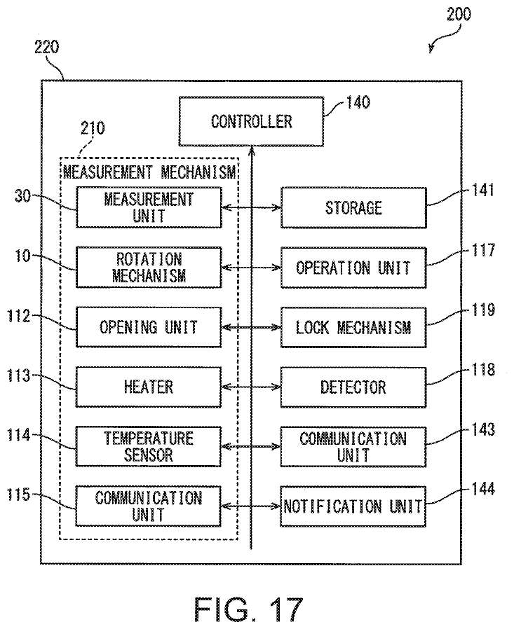

The measurement system according to the present embodiment is described with reference to FIGS. 16 to 17. As shown in FIG. 16, the measurement system 200 includes a measurement apparatus 210, and a server apparatus 220 communicably connected to the measurement apparatus 210 via a network 230. As shown in FIG. 17, the measurement apparatus 210 includes a measurement mechanism. The measurement apparatus 210 includes a measurement unit 30, a rotation mechanism 10, an opening unit 112, a heater 113, a temperature sensor 114, and a communication unit 115. As shown in FIG. 17, the server apparatus 220 includes a controller 140, a storage 141, an operation unit 117, a lock mechanism 119, a detector 118, a communication unit 143, and a notification unit 144.

The communication unit 115 of the measurement apparatus 210 is capable of transmitting information to an external device and receiving information from the external device. The communication unit 115 includes, for example, a communication module, an interface for external connection, and the like. The communication unit 115 may be capable of communicating by a plurality of types of communication methods. The connection to the network includes, for example, connection by wired LAN, wireless LAN, or the like.

The controller 140 may cause the server apparatus 220 to transmit the light intensity data for the foreign object detection and the light intensity data for the measurement result acquisition obtained by the measurement apparatus 210, and perform at least one of the foreign object detection process and the measurement result acquisition process. The controller 140 causes the communication unit 115 and the communication unit 143 to transmit at least one of the multiple light intensity data for the foreign object detection and the light intensity data for the measurement result acquisition, from the measurement apparatus 210 to the server apparatus 220 via the network 230. The controller 140 detects a foreign object based on the multiple light intensity data for the foreign object detection, and obtains a measurement result based on the light intensity data for the measurement result acquisition. A user can confirm information of at least one of the measurement result and the detection of the foreign object by accessing the server apparatus 220 with an arbitrary device connectable to the network 230.

The measurement apparatus 210 may transmit/receive information such as the measurement result and the detection of the foreign object, to/from the server apparatus 220. The controller 140 causes the communication unit 115 and the communication unit 143 to transmit information such as the measurement result and the detection of the foreign object, from the measurement apparatus 210 to the server apparatus 220 via the network 230. Upon receiving, by the server apparatus 220, the information such as the measurement result and the detection of the foreign object, the user can confirm the information such as the measurement result and the detection of the foreign object by accessing the server apparatus 220 with an arbitrary device connectable to the network 230.

The embodiments described above are examples for explaining the present invention, and the present invention is not limited thereto. The present invention can be implemented in various forms without departing from the gist thereof. For example, regarding a certain step in the processes or operations described above, the order of processes or operations and the execution subject can be freely changed as long as no contradiction in processes or operations occurs, such as using data that should not be available yet in that step.

### REMARKS

The present disclosure includes following items 1-20.

Item 1. A sample measurement system using a cartridge for preparing a measurement sample from a sample and a plurality of types of reagents, the system comprising:
a cartridge holder configured to detachably hold the cartridge containing the measurement sample in a measurement chamber having a transparent member;
a photodetector provided so as to face one surface of the cartridge held by the cartridge holder and configured to detect, via the transparent member, light emitted from the measurement sample in the measurement chamber;
a driver configured to move at least one of the cartridge held by the cartridge holder and the photodetector; and
a controller configured to obtain a measurement result of a target component in the measurement sample based on the light detected by the photodetector,
wherein the controller is configured to:
control the driver to arrange the photodetector at a plurality of positions relative to the measurement chamber, and control the photodetector to detect the light emitted from the measurement sample in the measurement chamber at the plurality of positions;
detect a foreign object in the measurement chamber based on a distribution of light amounts obtained by detecting the light at the plurality of positions; and
wherein the plurality of positions include:
a first position for detecting, by the photodetector, light from a first region of the measurement chamber; and
a second position for detecting, by the photodetector, light from a second region of the measurement chamber.

Item 2. The sample measurement system according to Item 1, wherein the controller is configured to detect the foreign object based on a non-uniformity of the distribution in the light amounts.

Item 3. The sample measurement system according to Item 1, wherein the driver is configured to move the cartridge to agitate the measurement sample, and the controller is configured to control the driver to move the cartridge so that the target component contained in the measurement sample is dispersed within the measurement chamber before obtaining the measurement result and detecting the foreign object.

Item 4. The sample measurement system according to Item 1, wherein at least one of the reagents include magnetic particles capable of binding to the target component, the driver is configured to move the cartridge to agitate the measurement sample, and the controller is configured to control the driver to move the cartridge so that the magnetic particles bound to the target component contained in the measurement sample are dispersed within the measurement chamber before obtaining the measurement result and detecting the foreign object.

Item 5. The sample measurement system according to Item 1, wherein the reagents include a first reagent and a second reagent, wherein the first reagent includes a labeling substance capable of specifically binding to the target component and the second reagent includes a luminescent substance capable of generating chemiluminescence by reacting with the labeling substance, and the photodetector is configured to detect the chemiluminescence produced by the luminescent substance.

Item 6. The sample measurement system according to Item 5, wherein the photodetector is configured to detect luminescence caused by a non-specific reaction of the luminescent substance and the foreign object.

Item 7. The sample measurement system according to Item 1, wherein the first region is a part of the measurement chamber, and the second region encompasses the first region and covers a wider range of the measurement chamber than the first region.

Item 8. The sample measurement system according to Item 7, wherein the controller is configured to obtain the measurement result based on the light detected by the photodetector at the second position.

Item 9. The sample measurement system according to Item 8, wherein the controller is configured to detect the foreign object based on detection of an increase in the light amounts localized in the first region.

Item 10. The sample measurement system according to Item 1, wherein the photodetector includes a photomultiplier tube.

Item 11. The sample measurement system according to Item 1, further comprising a housing configured to block light from outside, wherein the housing is configured to accommodate the cartridge and the photodetector.

Item 12. The sample measurement system according to Item 1, wherein the controller is configured to detect the foreign object in the measurement chamber based on a degree of similarity between multiple light intensity data derived from the light detected at the plurality of positions and a normal state of the multiple light intensity data.

Item 13. The sample measurement system according to Item 12, wherein the controller is configured to perform normalization of the multiple light intensity data and detect the foreign object in the measurement chamber based on the normalized multiple data.

Item 14. The sample measurement system according to Item 13, wherein the normalization of the multiple light intensity data is performed by dividing each of the multiple light intensity data by predetermined light intensity data.

Item 15. The sample measurement system according to Item 14, wherein the controller is configured to detect the foreign object in the measurement chamber based on a degree of similarity between predetermined reference data and at least one of the normalized multiple data.

Item 16. The sample measurement system according to Item 1, wherein:
the first position or the second position is a reference position where the photodetector receives the light emitted from the measurement sample toward the reference position; and
the controller is configured to:
obtain a relative value of light intensity detected at the first position with respect to a light intensity detected at the second position; and
detect the foreign object in the measurement chamber based on a degree of similarity between the obtained relative value and a relative value in a normal state.

Item 17. The sample measurement system according to Item 1, further comprising a storage configured to store a trained model trained using, as training data, light intensity data labeled as a normal state and an abnormal state, the abnormal state being a state in which the foreign object in the measurement chamber is detected, so as to output detection of the foreign object in the measurement chamber for multiple light intensity data based on the light detected at the plurality of positions, wherein the controller is configured to detect the foreign object in the measurement chamber based on the multiple light intensity data and the trained model.

Item 18. The sample measurement system according to Item 1, wherein the controller is configured to, in response to detecting the foreign object in the measurement chamber, add identification information indicating detection of the foreign object to the measurement result.

Item 19. The sample measurement system according to Item 1, wherein the photodetector includes a light receiving part and a frame provided around the light receiving part.

Item 20. A sample measurement method using a cartridge for preparing a measurement sample from a sample and a plurality of types of reagents, the method comprising steps of:
moving at least one of the cartridge containing the measurement sample in a measurement chamber having a transparent member and a photodetector provided so as to face one surface of the cartridge, so as to arrange the photodetector at a plurality of positions relative to the measurement chamber;
detecting, by the photodetector via the transparent member, the light emitted from the measurement sample in the measurement chamber at the plurality of positions; and
detecting a foreign object in the measurement chamber based on a distribution of light amounts obtained by detecting the light at the plurality of positions;
wherein the plurality of positions include:
a first position for detecting, by the photodetector, light from a first region of the measurement chamber; and
a second position for detecting, by the photodetector, light from a second region of the measurement chamber.

What is claimed is:

1. A sample measurement system using a cartridge for preparing a measurement sample from a sample and a plurality of types of reagents, the system comprising:
a cartridge holder configured to detachably hold the cartridge containing the measurement sample in a measurement chamber having a transparent member;
a photodetector provided so as to face one surface of the cartridge held by the cartridge holder and configured to detect, via the transparent member, light emitted from the measurement sample in the measurement chamber;
a driver configured to move at least one of the cartridge held by the cartridge holder and the photodetector; and
a controller configured to obtain a measurement result of a target component in the measurement sample based on the light detected by the photodetector,
wherein the controller is configured to:
control the driver to arrange the photodetector at a plurality of positions relative to the measurement chamber, and control the photodetector to detect the light emitted from the measurement sample in the measurement chamber at the plurality of positions;
detect a foreign object in the measurement chamber based on a distribution of light amounts obtained by detecting the light at the plurality of positions; and
wherein the plurality of positions include:
a first position for detecting, by the photodetector,
light from a first region of the measurement chamber; and
a second position for detecting, by the photodetector, light from a second region of the measurement chamber.

2. The sample measurement system according to claim 1, wherein the controller is configured to detect the foreign object based on a non-uniformity of the distribution in the light amounts.

3. The sample measurement system according to claim 1, wherein the driver is configured to move the cartridge to agitate the measurement sample, and
the controller is configured to control the driver to move the cartridge so that the target component contained in the measurement sample is dispersed within the measurement chamber before obtaining the measurement result and detecting the foreign object.

4. The sample measurement system according to claim 1, wherein at least one of the reagents include magnetic particles capable of binding to the target component,
the driver is configured to move the cartridge to agitate the measurement sample, and the controller is configured to control the driver to move the cartridge so that the magnetic particles bound to the target component contained in the measurement sample are dispersed within the measurement chamber before obtaining the measurement result and detecting the foreign object.

5. The sample measurement system according to claim 1, wherein the reagents include a first reagent and a second reagent, wherein the first reagent includes a labeling substance capable of specifically binding to the target component and the second reagent includes a luminescent substance capable of generating chemiluminescence by reacting with the labeling substance, and the photodetector is configured to detect the chemiluminescence produced by the luminescent substance.

6. The sample measurement system according to claim 5, wherein the photodetector is configured to detect luminescence caused by a non-specific reaction of the luminescent substance and the foreign object.

7. The sample measurement system according to claim 1, wherein the first region is a part of the measurement chamber, and the second region encompasses the first region and covers a wider range of the measurement chamber than the first region.

8. The sample measurement system according to claim 7, wherein the controller is configured to obtain the measurement result based on the light detected by the photodetector at the second position.

9. The sample measurement system according to claim 8, wherein the controller is configured to detect the foreign object based on detection of an increase in the light amounts localized in the first region.

10. The sample measurement system according to claim 1, wherein the photodetector includes a photomultiplier tube.

11. The sample measurement system according to claim 1, further comprising a housing configured to block light from outside, wherein the housing is configured to accommodate the cartridge and the photodetector.

12. The sample measurement system according to claim 1, wherein the controller is configured to detect the foreign object in the measurement chamber based on a degree of similarity between multiple light intensity data derived from the light detected at the plurality of positions and a normal state of the multiple light intensity data.

13. The sample measurement system according to claim 12, wherein the controller is configured to perform normalization of the multiple light intensity data and detect the foreign object in the measurement chamber based on the normalized multiple data.

14. The sample measurement system according to claim 13, wherein the normalization of the multiple light intensity data is performed by dividing each of the multiple light intensity data by predetermined light intensity data.

15. The sample measurement system according to claim 14, wherein the controller is configured to detect the foreign object in the measurement chamber based on a degree of similarity between predetermined reference data and at least one of the normalized multiple data.

16. The sample measurement system according to claim 1, wherein:
the first position or the second position is a reference position where the photodetector receives the light emitted from the measurement sample toward the reference position; and
the controller is configured to:
obtain a relative value of light intensity detected at the first position with respect to a light intensity detected at the second position; and
detect the foreign object in the measurement chamber based on a degree of similarity between the obtained relative value and a relative value in a normal state.

17. The sample measurement system according to claim 1, further comprising a storage configured to store a trained model trained using, as training data, light intensity data labeled as a normal state and an abnormal state, the abnormal state being a state in which the foreign object in the measurement chamber is detected, so as to output detection of the foreign object in the measurement chamber for multiple light intensity data based on the light detected at the plurality of positions, wherein the controller is configured to detect the foreign object in the measurement chamber based on the multiple light intensity data and the trained model.

18. The sample measurement system according to claim 1, wherein the controller is configured to, in response to detecting the foreign object in the measurement chamber, add identification information indicating detection of the foreign object to the measurement result.

19. The sample measurement system according to claim 1, wherein the photodetector includes a light receiving part and a frame provided around the light receiving part.

20. A sample measurement method using a cartridge for preparing a measurement sample from a sample and a plurality of types of reagents, the method comprising steps of:
moving at least one of the cartridge containing the measurement sample in a measurement chamber having a transparent member and a photodetector provided so as to face one surface of the cartridge, so as to arrange the photodetector at a plurality of positions relative to the measurement chamber;
detecting, by the photodetector via the transparent member, the light emitted from the measurement sample in the measurement chamber at the plurality of positions; and
detecting a foreign object in the measurement chamber based on a distribution of light amounts obtained by detecting the light at the plurality of positions;
wherein the plurality of positions include:
a first position for detecting, by the photodetector, light from a first region of the measurement chamber; and
a second position for detecting, by the photodetector, light from a second region of the measurement chamber.
